(19) United States
(12) Patent Application Publication
(10) Pub. No.: US 2017/0132731 A1
(43) Pub. Date: May 11, 2017

(54) INTELLECTUAL PROPERTY EVALUATION SYSTEM, INTELLECTUAL PROPERTY EVALUATION SYSTEM CONTROL METHOD, AND INTELLECTUAL PROPERTY EVALUATION PROGRAM

(71) Applicant: FRONTEO, Inc., Tokyo (JP)

(72) Inventors: Masahiro MORIMOTO, Tokyo (JP); Naritomo IKEUE, Tokyo (JP); Hideki TAKEDA, Tokyo (JP)

(21) Appl. No.: 15/321,977

(22) PCT Filed: Jul. 18, 2014
(86) PCT No.: PCT/JP2014/069177

§ 371 Date: Dec. 23, 2016

(51) Int. Cl. G06Q 50/18; G06F 17/30

(52) U.S. Cl. CPC G06Q 50/184; G06F 17/3053; G06F 17/30864

(57) ABSTRACT

An intellectual property evaluation system, control method, and program capable of analyzing and evaluating the relation between patent information and an intellectual property event promptly with less labor and good accuracy with respect to a large amount of the patent information are provided.

The intellectual property evaluation system includes: an element evaluation unit that evaluates an element for evaluating the relation between data regarding patent information and a specified intellectual property event and re-evaluates the evaluated element; a relation evaluation unit that evaluates the relation between the data regarding the patent information and the specified intellectual property event on the basis of the element and re-evaluates the relation between the data regarding the patent information and the specified intellectual property event on the basis of the element updated by being re-evaluated on the basis of the evaluated relation; a threshold value specifying unit that specifies a threshold value with respect to the relation acquired or updated by the relation evaluation unit; and a patent information analysis unit that evaluates the relation between the patent information and the specified intellectual property event by controlling the element evaluation unit, the relation evaluation unit, and the threshold value specifying unit.

### TECHNICAL FIELD

The present invention relates to an intellectual property evaluation system, an intellectual property evaluation system control method, and an intellectual property evaluation program.

### BACKGROUND ART

Conventionally, when a crime or a legal conflict relating to computers such as unauthorized access or leakage of confidential information occurs, there have been proposed means or techniques that collect and analyze equipment, data, and electronic records required for investigation into the cause of the crime or legal conflict and clarify legal evidences of the crime or legal conflict.

Furthermore, procedures such as eDiscovery (electronic discovery) are required for a civil lawsuit in the United State of America and both a plaintiff and a defendant involved in the lawsuit are liable to submit all pieces of related digital information as evidences. Therefore, there are suggested means and techniques for submitting digital information recorded in computers and/or servers as the evidences in accordance with eDiscovery.

Meanwhile, due to the rapid development and spreading of information technologies, most information in today's business world is produced by computers, so that digital information is abundant even within companies.

Therefore, in the process of analyzing and evaluating patent information, it is required to extract necessary information from an enormous amount of accumulated digital information and process it properly. However, since the amount of accumulated information has been increasing more and more, it has become difficult to properly extract and process the accumulated information. Therefore, mistakes occur where even confidential digital information, which is not necessarily related with an intellectual property lawsuit, may be included in the evidentiary materials. Another problem is that confidential document information which is not related to the relevant intellectual lawsuit is submitted.

In recent years, techniques related to document information in forensic systems have been proposed in PTL 1 to PTL 3. PTL 1 discloses a forensic system that: designates a specific person from at least one or more users included in user information; extracts only digital document information which is accessed by the specific person on the basis of access history information about the designated specific person; sets accessory information indicating whether each document file of the extracted digital document information is related to a lawsuit or not; and outputs the document files related to the lawsuit on the basis of the accessory information.

Furthermore, PTL 2 discloses a forensic system that: displays recorded digital information; sets user-identifying information indicating to which one of users included in user information each of a plurality of document files is related; sets settings so that the set user-identifying information will be recorded in a storage unit; designates at least one or more users; searches for a document file in which the user-specifying information corresponding to the designated user is set; sets accessory information indicating whether the searched document file is related to a lawsuit or not, on a display unit; and outputs the document file related to the lawsuit on the basis of the accessory information.

Furthermore, PTL 3 discloses a forensic system that: receives designation of at least one or more document files included in digital document information; receives designation indicating into which language the designated document file should be translated; translates the designated document file into the designated language; extracts a common document file indicating the same content as the designated document file from the digital document information recorded in a recording unit; generates translation-related information indicating that the extracted common document file is translated by employing the translation content of the translated document file; and outputs a document file related to a lawsuit on the basis of the translation-related information.

### CITATION LIST

### Patent Literature

PTL 1: Japanese Patent Application Laid-Open (Kokai) Publication No. 2011-209930

PTL 2: Japanese Patent Application Laid-Open (Kokai) Publication No. 2011-209931

PTL 3: Japanese Patent Application Laid-Open (Kokai) Publication No. 2012-32859

### SUMMARY OF INVENTION

### Problems to be Solved by the Invention

However, for example, the forensic systems like those described in PTL 1 to PTL 3 would collect an enormous amount of document information of users who use a plurality of computers and servers.

Regarding work to classify whether such an enormous amount of digitalized document information is valid as evidential materials for a lawsuit or not, a user(s) called a “reviewer(s)” needs to visually check and classify each piece of the relevant document information, thereby causing a problem requiring a large amount of labor and cost.

So, in light of the above-described circumstances, it is an object of the present invention to provide an intellectual property evaluation system, intellectual property evaluation system control method, and intellectual property evaluation program capable of analyzing and evaluating the relation between patent information and an intellectual property event promptly with less labor and good accuracy with respect to a large amount of the patent information.

### Means for Solving the Problems

In order to solve the above-described problems, an intellectual property evaluation system according to the present invention is an intellectual property evaluation system for evaluating a relation with a specified intellectual property event from data regarding acquired patent information, wherein the intellectual property evaluation system includes: an element evaluation unit that evaluates an element for evaluating the relation between the data regarding the acquired patent information and the specified intellectual property event and re-evaluates and updates the evaluated element; a relation evaluation unit that evaluates the relation between the data regarding the acquired patent information and the specified intellectual property event on the basis of the element and re-evaluates and updates the relation between the data regarding the acquired patent information and the specified intellectual property event on the basis of the element which is updated by being re-evaluated on the basis of the evaluated relation; a threshold value specifying unit that specifies a threshold value with respect to the relation acquired or updated by the relation evaluation unit and compares the relation or the updated relation with the threshold value; and a patent information analysis unit that acquires the re-evaluated relation between the acquired patent information and the specified intellectual property event by controlling controls the element evaluation unit, the relation evaluation unit, and the threshold value specifying unit, and outputs the re-evaluated relation according to comparison between the re-evaluated relation and the threshold value as a result of the evaluation of the relation between the patent information and the specified intellectual property event.

The intellectual property evaluation system according to the present invention may include a right infringement analysis evaluation unit that specifies a patent, which is a basis for exercising a right, and evaluates a relation that a product has with the specified patent which is the basis for exercising the right.

The intellectual property evaluation system according to the present invention may include an infringing nature analysis evaluation unit that specifies a product and evaluates a relation that a patent acquired by searching for the specified product has with the specified product.

The intellectual property evaluation system according to the present invention may include a trade secret management evaluation unit that: extracts data regarding a trade secret and evaluates a relation between the extracted data regarding the trade secret and the trade secret; monitors external taking-out or transmission preparation work of the extracted data regarding the trade secret when the relation exceeds a specified threshold value; and executes processing for dealing with the external taking-out or the preparation work when the external taking-out or the preparation work is detected.

The intellectual property evaluation system according to the present invention may include an electronic stamp management evaluation unit that: selects an object of an electronic stamp; evaluates an element for specifying the object of the electronic stamp; extracts electronic stamp candidate data from the acquired data; evaluates a relation of the electronic stamp candidate data on the basis of the evaluated element; updates the evaluated element and relation; and certifies electronic stamp processing and transmits the electronic stamp processing when the evaluated or updated relation exceeds a specified value.

An intellectual property evaluation system control method according to the present invention is an intellectual property evaluation system control method for evaluating a relation with a specified intellectual property event from data regarding acquired patent information, wherein the intellectual property evaluation system control method includes: an element evaluation step of evaluating an element for evaluating the relation between the data regarding the acquired patent information and the specified intellectual property event; a relation evaluation step of evaluating the relation between the data regarding the patent information acquired by the data input accepting unit and the specified intellectual property event on the basis of the element;

an element re-evaluation step of re-evaluating the element for evaluating the relation between the data regarding the acquired patent information and the specified intellectual property event; a relation re-evaluation step of re-evaluating the relation between the data regarding the acquired patent information and the specified intellectual property event on the basis of the re-evaluated element; a comparison step of comparing the re-evaluated relation with a threshold value specified with respect to the relation; and an output step of outputting the re-evaluated relation according to the comparison with the threshold value as a result of the evaluation of the relation between the patent information and the specified intellectual property event.

An intellectual property evaluation program according to the present invention is an intellectual property evaluation program for evaluating a relation with a specified intellectual property event from data regarding acquired patent information, wherein the intellectual property evaluation program causes a computer to implement: an element evaluation function that evaluates an element for evaluating the relation between the data regarding the acquired patent information and the specified intellectual property event; a relation evaluation function that evaluates the relation between the data regarding the patent information acquired by the data input accepting unit and the specified intellectual property event on the basis of the element; an element re-evaluation function that re-evaluates the element for evaluating the relation between the data regarding the acquired patent information and the specified intellectual property event; a relation re-evaluation function that re-evaluates the relation between the data regarding the acquired patent information and the specified intellectual property event on the basis of the re-evaluated element; a comparison function that compares the re-evaluated relation with a threshold value specified with respect to the relation; and an output function that outputs the re-evaluated relation according to the comparison with the threshold value as a result of the evaluation of the relation between the patent information and the specified intellectual property event.

### Advantageous Effects of Invention

The intellectual property evaluation system, intellectual property evaluation system control method, and intellectual property evaluation program according to the present invention can promptly perform analysis evaluation work on a large amount of patent information while reducing labor for the analysis and evaluation work by repeatedly executing element evaluation, which is the basis for relation evaluation, and the relation evaluation more than once, thereby making it possible to perform analysis evaluation with high accuracy with respect to the relation between the patent information and an intellectual property event.

### BRIEF DESCRIPTION OF DRAWINGS

FIG. 1 is a block diagram of an intellectual property evaluation system according to an embodiment of the present invention;

FIG. 2 is a conceptual diagram for conceptually explaining functions of the intellectual property evaluation system according to an embodiment of the present invention;

FIG. 3 is a flowchart of an example for performing relation evaluation by setting a threshold value as a reference after performing the relation evaluation;

FIG. 4 is a flowchart illustrating an example of analysis evaluation of exercise of rights according to an embodiment of the present invention;

FIG. 5 is a flowchart illustrating an example of analysis evaluation of infringing nature evaluation (clearance) according to an embodiment of the present invention;

FIG. 6 is a flowchart illustrating an example of management evaluation of trade secret data according to an embodiment of the present invention;

FIG. 7 is a flowchart illustrating an example of management evaluation of an electronic stamp (electronic notarization) according to an embodiment of the present invention; and

FIG. 8 is a diagram illustrating an example of a claim chart created by the intellectual property evaluation system according to an embodiment of the present invention.

### DESCRIPTION OF EMBODIMENTS

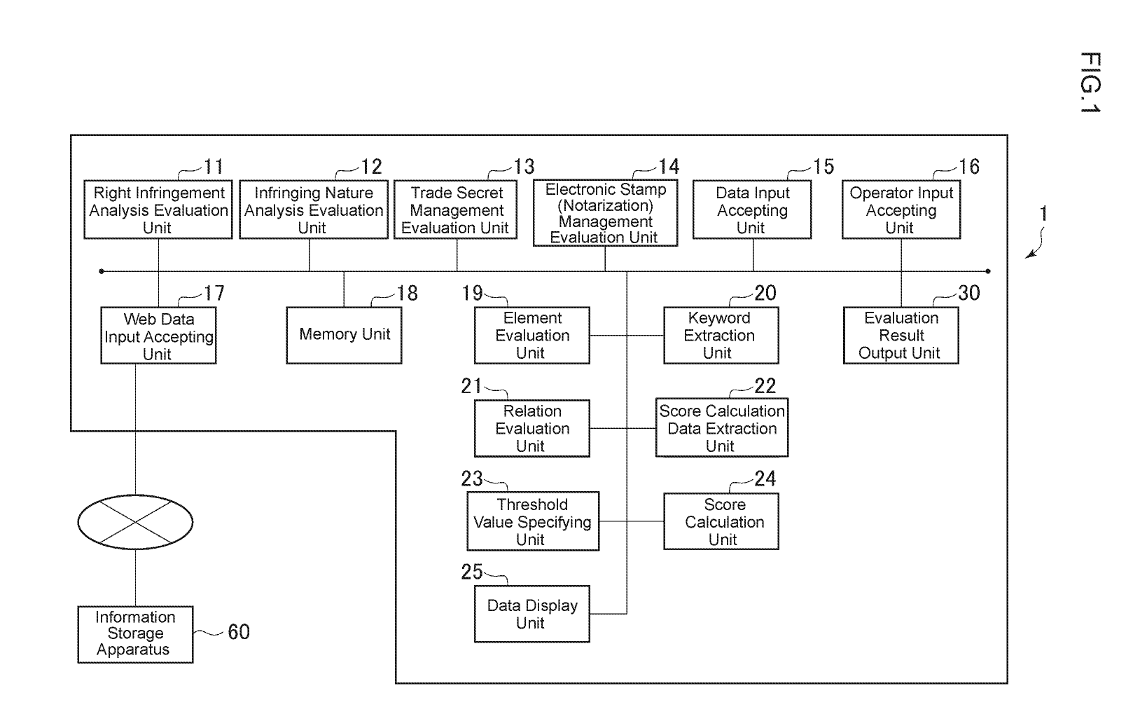

An embodiment of the present invention will be explained below with reference to FIG. 1 to FIG. 8.

### [Outlines of Intellectual Property Evaluation System]

FIG. 1 is a block diagram of an intellectual property evaluation system according to an embodiment of the present invention. Referring to FIG. 1, an intellectual property evaluation system 1 according to an embodiment of the present invention includes a right infringement analysis evaluation unit 11 for evaluating patent information and an infringing nature analysis evaluation unit 12. The right infringement analysis evaluation unit 11 analyzes and evaluates right exercisability of patents retained by a user of the system. Moreover, the infringing nature analysis evaluation unit 12 analyzes and evaluates whether its own product infringes upon other people's patents or not.

Furthermore, the intellectual property evaluation system according to the embodiment of the present invention constitutes one form of an information processing apparatus and includes a data input accepting unit 15, an operator input accepting unit 16, a web data input accepting unit 17, a memory unit 18, a data display unit 25, and an evaluation result output unit 30 which the information processing apparatus would generally include.

Furthermore, the intellectual property evaluation system 1 according to the embodiment of the present invention includes an element evaluation unit 19, a keyword extraction unit 20, a relation evaluation unit 21, a score calculation data extraction unit 22, a threshold value specifying unit 23, and a score calculation unit 24 which actually take charge of, and execute, patent information analysis evaluation processing that is executed by the right infringement analysis evaluation unit 11 and the infringing nature analysis evaluation unit 12.

Moreover, the intellectual property evaluation system according to the embodiment of the present invention may include either a trade secret management evaluation unit 13 which manages and evaluates data regarding trade secrets, or an electronic stamp management evaluation unit 14 which executes an electronic stamp (electronic notarization). The trade secret management evaluation unit 13 and the electronic stamp management evaluation unit 14 may have their processing executed by the element evaluation unit 19, the keyword extraction unit 20, the relation evaluation unit 21, the score calculation data extraction unit 22, the threshold value specifying unit 23, and the score calculation unit 24 which are mentioned above and respectively take charge of their processing.

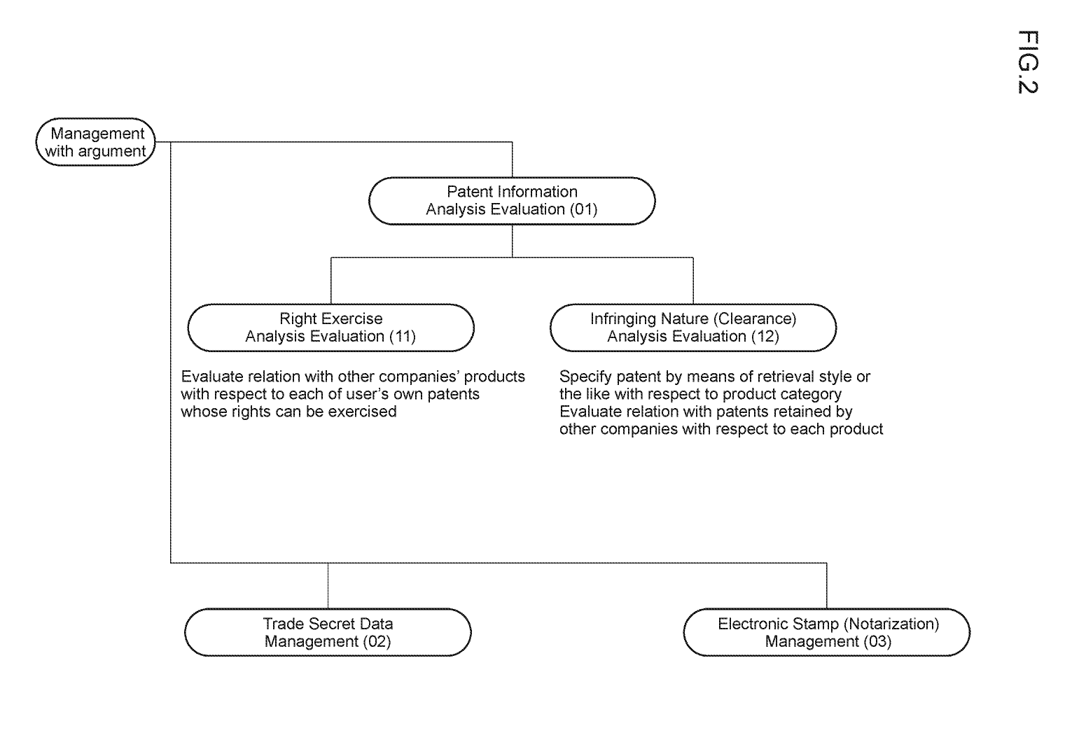

FIG. 2 is a conceptual diagram for conceptually explaining functions of the intellectual property evaluation system according to the embodiment of the present invention. The intellectual property evaluation system according to the embodiment of the present invention executes each function of the intellectual property evaluation system by designating arguments (01 to 03 and 11 to 12). Analysis evaluation of patent information is executed by designating argument (01). Furthermore, right exercise analysis evaluation is executed by designating argument (11), so that the relation with other companies' products is evaluated with respect to each patent which is owned by a user of the system and regarding which the user has the possibility to exercise their right. Furthermore, infringing nature (clearance) analysis evaluation is executed by designating argument (12), so that patents are specified by using a retrieval style or the like with respect to product categories of the user's products and the relation with patents retained by other companies is evaluated with respect to each product. Trade secret management evaluation is executed by designating argument (02) and electronic stamp (electronic notarization) management evaluation is executed by designating argument (03).

The element evaluation unit 19, the keyword extraction unit 20, the score calculation unit 24, the relation evaluation unit 21, and the threshold value specifying unit 23 according to the embodiment of the present invention and their operations will be described. The element evaluation unit 19 evaluates each of data elements included in judged data on the basis of specified standards. The score calculation unit 24 calculates a score indicative of strength of the relation between the data and a specified event by using the results evaluated by the element evaluation unit 19 (element information). The score calculation unit 24 outputs the calculated score to the threshold value specifying unit 23. Furthermore, when data is input from the data input accepting unit 15, the score calculation unit 24 calculates a score with respect to the data and outputs the calculated store to the threshold value specifying unit 23.

In other words, the score calculation unit 24 can calculate the score of the relevant data by totalizing weights of data elements included in the data. Specifically speaking, the score calculation unit 24 generates an element vector indicating whether a specified data element is included in the data or not. The above-mentioned element vector is a vector indicating whether the specified data element associated with the relevant element is included in the above-mentioned data 1 or not, by having each element of the relevant element vector taking the value “0” or “1”. Then, the score calculation unit 24 calculates score S of the above-mentioned data 1 by calculating an inner product between the above-mentioned element vector (column vector) and a weight vector (column vector whose element(s) is the weight of each data element) as indicated in the following expression.

S=w^{T}·s [Math. 1]

In the above expression, s represents the element vector and W represents the weight vector. Incidentally, T represents transposition of the matrix/vectors (switching between a row and a column).

Alternatively, the score calculation unit 24 may calculate score S according to the following expression.

$$S = \frac{{\sum }_{j - 1}^{N} {m}_{j} {w}_{j}^{2}}{{\sum }_{i - 1}^{N} {w}_{i}^{2}} \qquad [ Math . 2 ]$$

In the above expression, mⱼ represents appearance frequency of a j-th data element and wᵢ represents the weight of an i-th data element.

It should be noted that the score calculation unit 24 may calculate the score on the basis of the evaluation result of a first data element included in the data (the weight of the first data element) and the evaluation result of a second data element included in the data (the weight of the second data element). Specifically speaking, when the first data element appears in the data, the score calculation unit 24 can calculate the score of the data in consideration of frequency at which the second data element appears in the relevant data (that is, also referred to as correlation or co-occurrence between the first data element and the second data element). As a result, the intellectual property evaluation system according to the embodiment of the present invention can calculate the score in consideration of the correlation between the data elements, so that it can extract the data 1 related to a specified event with higher accuracy.

The threshold value specifying unit 23 judges whether the data satisfies specified conditions or not, on the basis of the score calculated by the score calculation unit 24. For example, the threshold value specifying unit 23 may judge whether the relevant score exceeds a threshold precision value (a specified threshold value) or not, as one of the above-mentioned specified conditions by comparing the score with the threshold precision value.

When unjudged data regarding which whether it is related to a specified event or not is not judged is newly acquired, the relation evaluation unit 21 may evaluate the relation between the relevant unjudged data and the specified event on the basis of judged data regarding which whether it is related to the specified event or not is judged by, for example, a lawyer(s). For example, when the score calculated by the score calculation unit as an index indicative of the relation between the unjudged data and the specified event exceeds a threshold value, the relation evaluation unit 21 may evaluate that the relevant unjudged data is related to the specified event.

The threshold value specifying unit 23 identifies a minimum score that can exceed a target value (target precision ratio) set to a precision ratio indicative of a ratio of the data judged to be related to the specified event to a data group including a specified number of pieces of data, as the threshold precision value. Specifically speaking, when scores are input from the score calculation unit, the threshold value specifying unit 23 arranges the relevant scores in descending order. Next, the threshold value specifying unit scans the review result assigned to the relevant data in order from the data having a maximum score (the score ranked first) and sequentially calculates a ratio (precision ratio) of the number of pieces of data to which the review result indicating that the relevant data is “related to the specified event” is assigned, to the number of pieces of data regarding which scanning has been completed at that moment.

For example, when the number of pieces of data to which the review result is assigned is 100 and scanning of data with scores ranked first to 20^{th} has been completed and if the number of pieces of data to which the review result 5a indicating that the relevant data is “related to the specified event” is assigned is 18, the threshold value specifying unit calculates the precision ratio as 0.9 (18/20). As another example, when scanning of data with scores ranked first to 40^{th} has been completed and if the number of pieces of data to which the review result indicating that the relevant data is “related to the specified event” is assigned is 35, the threshold value specifying unit calculates the precision ratio as 0.875 (35/40).

The threshold value specifying unit 23 calculates all precision ratios regarding the data and identifies the minimum score that can exceed the target precision ratio. Specifically speaking, when the threshold value specifying unit 23 scans the precision ratios calculated regarding the relevant data in order from the data having the minimum score (the score ranked 100th) and the relevant precision ratio exceeds the target precision ratio, it outputs the score corresponding to the relevant precision ratio as the minimum score capable of maintaining the above-mentioned target precision ratio (the threshold precision value) to the threshold value specifying unit 23 and the memory unit 18.

When element information is input from the element evaluation unit, the memory unit 18 associates data elements included in the relevant element information with evaluation results of the data elements (weights) and stores them in the memory unit. Accordingly, the intellectual property evaluation system can extract the data related to the specified event by analyzing the current data on the basis of the result of analyzing past data (the weights as the result of evaluation of the data elements). Furthermore, when the threshold precision value is input from the threshold value specifying unit, the memory unit 18 stores the relevant threshold precision value in the memory unit 18.

### [Recalculation of Weight]

Data determined by the intellectual property evaluation system that they are related to a specified case may be displayed on the data display unit 25. The data displayed on the data display unit 25 may be peer-reviewed by, for example, a lawyer(s) and whether the results of judgment by the intellectual property evaluation system are reasonable or not may be fed back by the lawyer(s) or the like from the operator input accepting unit 16. The element evaluation unit 19 can re-evaluate each data element on the basis of the above-mentioned feedback.

Specifically speaking, the element evaluation unit 19 can recalculate the weight on the basis of the feedback newly acquired with respect to the judgment by the intellectual property evaluation system. As a result, the intellectual property evaluation system can acquire the weight, which matches the object data to be analyzed, and calculate the score accurately on the basis of the relevant weight, and thereby extract the data related to the specified event with higher accuracy.

The feedback by advices from the layers or the like has been explained as an example; however, the intellectual property evaluation system may automatically recalculate the weight on the basis of internally stored information.

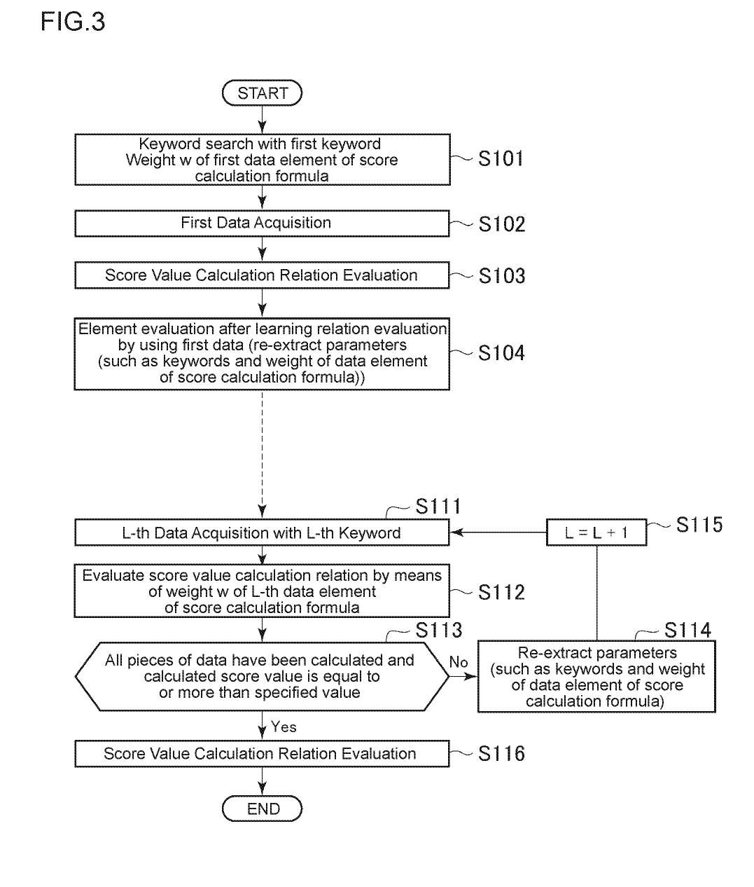

FIG. 3 is a flowchart illustrating an example of performing relation evaluation using a threshold value as a reference after performing the relation evaluation. A first-time keyword(s) is set for a first-time keyword search. Furthermore, weighting w of a first-time data element(s) of a score calculation formula used for the first time is set (S101). Data is acquired for the first time (S102). A score value is calculated for the data acquired for the first time and the relation is evaluated (S103). After learning the relation evaluation about the data acquired for the first time, the element(s) used for the relation evaluation for the first time is re-evaluated and parameters such as the keyword(s) and the weighting of the data element(s) of the score calculation formula are re-extracted (S104).

Next, the relation evaluation for an L−th time (L≧2) will be described. Data is acquired for the L−th time by using a keyword(s) for the L−th time which has been extracted in the process of examining and learning the relation evaluation for an (L−1)th time (S111). A score value is calculated on the basis of the weighting w of an L−th time data element(s) of the score calculation formula with respect to the data acquired for the L−th time and the relation is evaluated (S112).

When not all pieces of data have been acquired or the threshold value specifying unit does not determine that the calculated score value is equal to or more than a specified value, the parameters such as the keyword(s) and the weighting of the data element(s) of the score calculation formula are re-extracted (S113 to S115) and data is acquired for an (L+1)th time and (L+1)th time relation evaluation is performed. When all the pieces of data have been acquired or the threshold value specifying unit determines that the calculated score value is equal to or more than the specified value (S113), the score value is calculated and the relation is evaluated and the calculation result of the score value and the evaluation result of the relation evaluation are output from the evaluation result output unit (S116).

The intellectual property evaluation system, the intellectual property evaluation system control method, and the intellectual property evaluation program according to the embodiment of the present invention can analyze and evaluate the relation with an intellectual property event with respect to a large amount of patent information promptly with less labor and good accuracy by repeatedly executing the element evaluation, which is the basis for the relation evaluation, and the relation evaluation more than once.

### [Analysis Evaluation of Exercise of Rights]

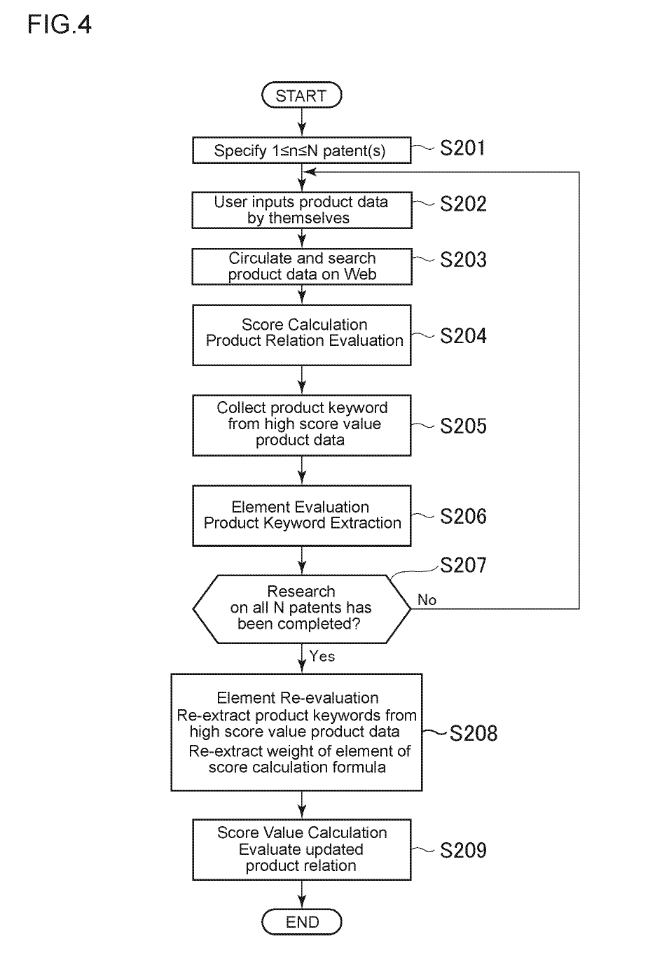

The analysis evaluation of exercise of rights using the intellectual property evaluation system according to the embodiment of the present invention will be explained below. FIG. 4 is a flowchart illustrating an example of the analysis evaluation of exercise of rights according to an embodiment of the present invention. A patent(s) whose right(s) can be exercised (the quantity of such patent(s): 1≦n≦N) is specified (S201). The user themselves inputs other companies' product data whose rights can be exercised.

Examples of other companies' product data include specifications, manuals, and catalogues. Other companies' patent documents can sometimes be cited as other companies' product data. A patent document of another company is identified with a patent number (the above-described processing: S202). Other companies' product data whose rights can be exercised are circulated and searched on the web by a method called rolling (S203).

Next, scores of products are calculated with respect to the patent(s) and the relation between the products is evaluated (S204). Product keywords are collected from high-score-value product data (S205). The elements are re-evaluated and the product keywords are extracted (S206). The relation evaluation is performed with respect to all the patents whose quantity is N (S207). The elements are re-evaluated, the product keywords are re-extracted from the high-score-value product data, and weighting of the elements of the score calculation formula is re-extracted (S208).

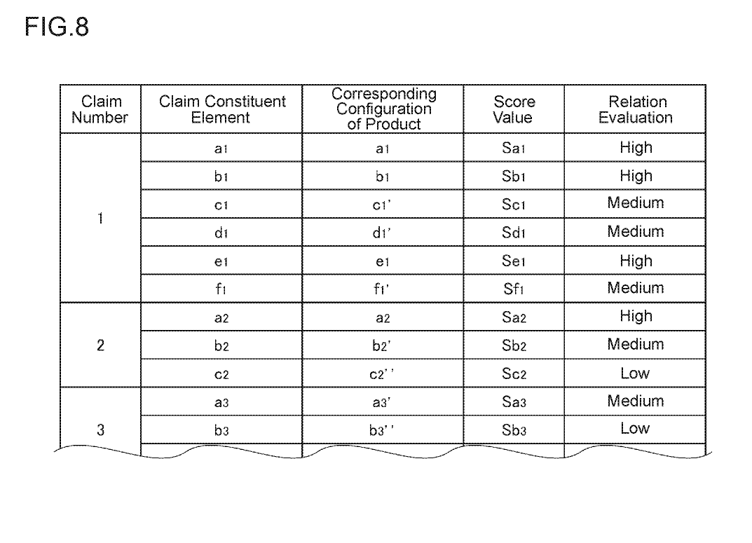

The score values are calculated by using the re-extracted elements and the weighting of the re-extracted elements and the updated relation between the products is evaluated (S209). The intellectual property evaluation system according to the embodiment of the present invention can also create a claim chart on the basis of the evaluated relation. An example of the claim chart created by the intellectual property evaluation system according to the embodiment of the present invention is illustrated in FIG. 8.

The intellectual property evaluation system, the intellectual property evaluation system control method, and the intellectual property evaluation program according to the embodiment of the present invention as described above can analyze and evaluate the relation with a right exercise (right infringement) event with respect to a large amount of patent information promptly with less labor and good accuracy.

### [Analysis Evaluation of Infringing Nature Evaluation (Clearance)]

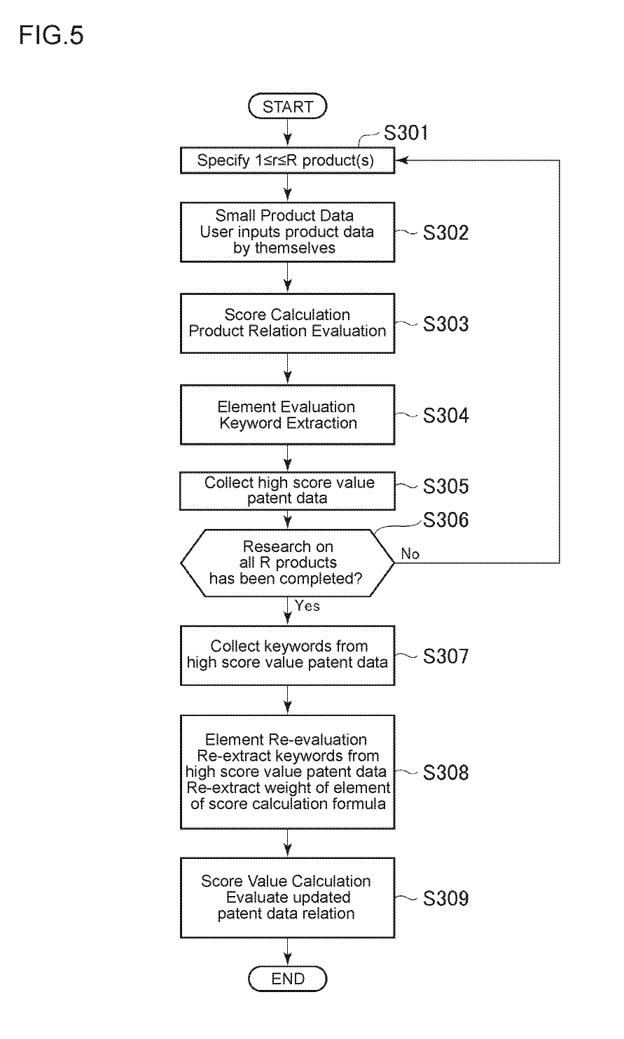

The analysis evaluation of infringing nature evaluation (clearance) will be explained below. The infringing nature evaluation (clearance) is to evaluate whether the user's own product infringes upon other people's patents or not. FIG. 5 is a flowchart illustrating an example of the analysis evaluation of the infringing nature evaluation (clearance). Regarding the infringing nature evaluation, the user's product(s) r (quantity: 1≦r≦R) is firstly specified (S301). The specified product may sometimes be under development, so that an amount of information about the user's specified product data may often be small. Keywords are extracted from the small amount of product data by using a retrieval style (S302).) Patents are searched by using the keywords and whether the patents found by the search have the relation with the user's product or not is evaluated by, for example, calculating scores (S303).

Elements are evaluated and the keywords are further extracted (S304). Furthermore, high-score-value patent data are collected while evaluating the relation (S305). When research on all the products whose quantity is R is completed (S306), the collected high-score-value patent data are re-evaluated (S307). The elements are re-evaluated on the basis of the collected high-score-value patent data, and the keywords are re-extracted from the high-score-value patent data.

Furthermore, weighting of the elements of the score calculation formula is re-extracted (S308). The score values are calculated by using the re-extracted elements and the weighting of the re-extracted elements and the weighting of the re-evaluated elements and the infringing nature of the product is analyzed and evaluated by evaluating the relation with other people's updated patent data (S309). When the relation with other people's patent data satisfies a specified value, it is output from the evaluation result output unit 16 of the intellectual property evaluation system 1.

The intellectual property evaluation system, the intellectual property evaluation system control method, and the intellectual property evaluation program according to the embodiment of the present invention as described above can analyze and evaluate the relation with an infringing nature evaluation (clearance) event with respect to a large amount of patent information promptly with less labor and good accuracy.

### [Management Evaluation of Trade Secrets]

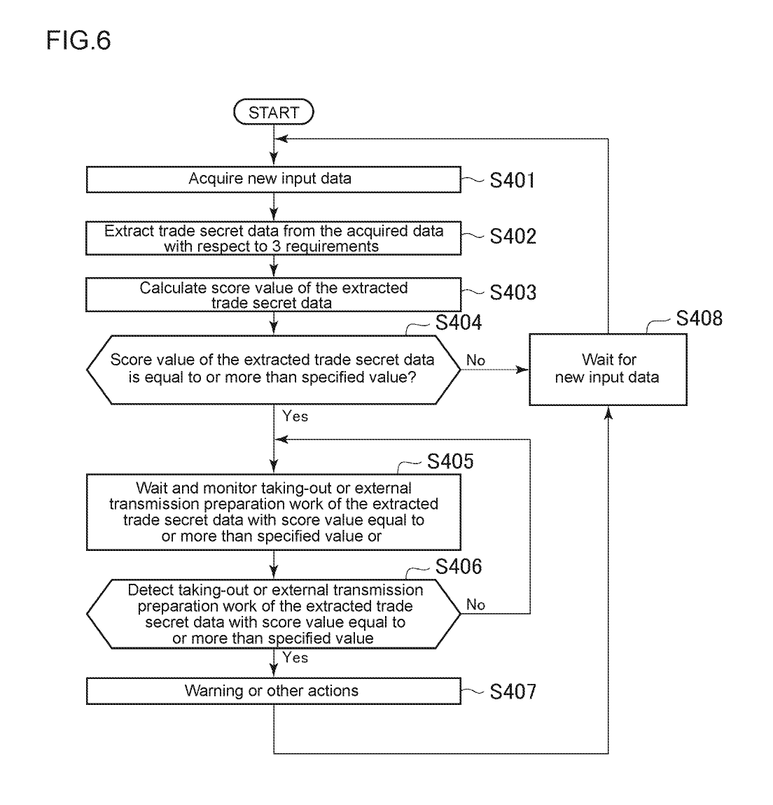

Management evaluation of trade secret data by using the intellectual property evaluation system according to an embodiment of the present invention will be explained. FIG. 6 is a flowchart illustrating an example of the management evaluation of the trade secret data. The intellectual property evaluation system according to the embodiment of the present invention acquires new input data (S401). The trade secret data are extracted from the acquired data with respect to three requirements (confidentiality, availability, and non-public nature) (S402). Score values of the extracted trade secret data are calculated (S403).

Whether the score of the extracted trade secret data is equal to or more than a specified value or not is judged (S404). When the score of the extracted trade secret data is equal to or more than a specified value, the intellectual property evaluation system waits and monitors taking-out or external transmission preparation work of the extracted trade secret data whose score value is equal to or more than the specified value (S405). When the taking-out or the external transmission preparation work of the extracted trade secret data whose score value is equal to or more than the specified value is detected (S406), processing for giving warning or hindering the taking-out or the external transmission is executed (S407). When the above-described processing from S401 to S407 is not executed, the intellectual property evaluation system waits to acquire new input data (S408).

The intellectual property evaluation system, the intellectual property evaluation system control method, and the intellectual property evaluation program according to the embodiment of the present invention as described above can manage and evaluate the relation with a trade secret event with respect to a large amount of patent information promptly with less labor and good accuracy. As a result, it is possible to impose limitations on taking-out and transmission of data regarding the trade secrets.

### [Management Evaluation of Electronic Stamp (Electronic Notarization)]

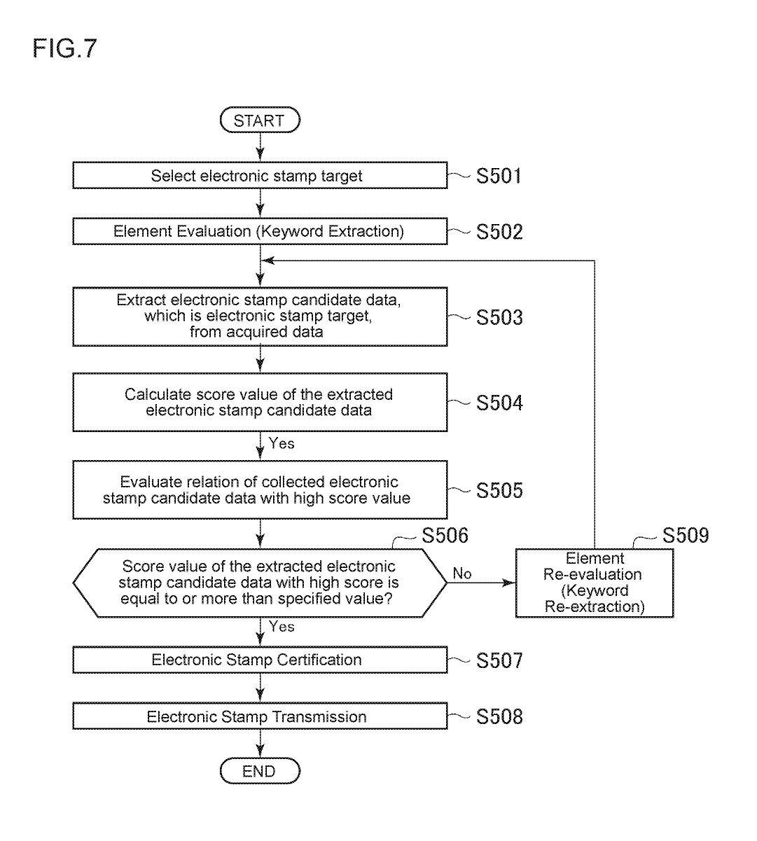

Management evaluation of an electronic stamp (electronic notarization) using the intellectual property evaluation system according to an embodiment of the present invention will be explained. FIG. 7 is a flowchart illustrating an example of the management evaluation of the electronic stamp (electronic notarization). An object of the electronic stamp is selected (S501). Elements are evaluated and keywords are extracted according to the selected object of the electronic stamp (S502). Electronic stamp candidate data which become objects of the electronic stamp are extracted from the acquired data by using the extracted keywords (S503).

Score values of the extracted electronic stamp candidate data are calculated (S504). The electronic stamp candidate data with high score values are collected and the relation between the collected electronic stamp candidate data is evaluated (S505). Whether the relevant score value of the collected electronic stamp candidate data with a high score value is equal to or more than a specified value or not is judged (S506). When the score value of the collected electronic stamp candidate data with the high score value is not equal to or more than the specified value, the elements are re-evaluated, the keywords are re-extracted, and the score values of the electronic stamp candidate data are recalculated (S509).

Data which is most suited as the object of the electronic stamp (electronic notarization) is selected from the collected electronic stamp candidate data with the high score values (S506), This is because the data which is most suited as the object of the electronic stamp (electronic notarization) needs to be selected from among the collected electronic stamp candidate data with the high score values in consideration of procedures and burdens of expenses when the electronic stamp (electronic notarization) is performed by an external institution. The most suited data is certified as the object of the electronic stamp (S507), The data certified as the object of the electronic stamp is transmitted (S508).

The intellectual property evaluation system, the intellectual property evaluation system control method, and the intellectual property evaluation program according to the embodiment of the present invention as described above can manage and evaluate a large amount of patent information promptly with less labor and good accuracy. As a result, it is possible to select data suited for the electronic stamp (electronic notarization) from the large amount of patent information promptly with less labor and good accuracy.

### [Implementation Examples by Software]

A control block of the intellectual property evaluation system may be implemented by a logical circuit (hardware) formed on, for example, an integrated circuit (IC chip) or may be implemented by software using a CPU (Central Processing Unit). In the latter case, the intellectual property evaluation system includes, for example: a CPU for executing commands of the intellectual property evaluation program which is software for implementing each function; a ROM (Read Only Memory) or a storage device (collectively referred to as the “storage media”) in which the above-mentioned intellectual property evaluation program and various kinds of data are recorded in a manner such that they can be read by the computer (or CPU); and a RAM (Random Access Memory) for expanding the above-mentioned intellectual property evaluation program. Then, the object of the present invention is achieved as the computer (or CPU) reads the above-mentioned intellectual property evaluation program from the above-mentioned storage media and executes it. As the above-mentioned storage media, “tangible media which are not temporary” such as tapes, disks, cards, semiconductor memories, or programmable logical circuits can be used. Furthermore, the above-mentioned intellectual property evaluation program may be supplied to the above-mentioned computer via an arbitrary transmission medium capable of transmitting the intellectual property evaluation program (such as a communication network or a broadcast wave). The present invention can also be implemented in a form of a data signal embedded in a carrier wave in which the above-mentioned intellectual property evaluation program is embodied via electronic transmission.

### [Supplement 1]

The present invention is not limited to each of the aforementioned embodiments and various changes can be made within the scope indicated in claims and embodiments which can be obtained by combining technical means respectively disclosed in different embodiments as appropriate are also included in the technical scope of the present invention. Furthermore, a new technical feature can be formed by combining the technical means disclosed in each embodiment.

### [Supplement 2]

Digital information including patent information, user information and access history information is acquired; a specific person is designated from among users included in the user information; only patent information accessed by the specific person is extracted on the basis of the access history information about the designated specific person; accessory information indicating whether a document file included in the extracted patent data is related to a specified intellectual property event or not is set; and the document file related to the specified intellectual property event is output on the basis of the accessory information.

Digital information including patent data and user information is acquired; user identifying information indicating which one of users included in the user information is related is set; the user is designated; a document file to which the user identifying information corresponding to the designated user is set is searched for; accessory information indicating whether the searched document file is related to a specified intellectual property event or not is set; and the document file related to the specified intellectual property event is output on the basis of the accessory information.

Digital information including patent information and user information is acquired; designation of into which language document files included in the patent information should be translated is accepted; the document files are translated; common document files indicating the same content as that of a designated document file are extracted from the patent information; translation related information indicating that the extracted common document files have been translated by employing the translation content of the translated document files is generated; and document files related to a specified intellectual property event are output on the basis of the translation related information.

(1a) Categorization sign A, (1b) keywords included in patent information (patent documents) to which categorization sign A is assigned, and (1c) keyword correspondence information indicative of a correspondence relation between categorization sign A and the keywords are stored in a keyword database; (2a) categorization sign B, (2b) related terms which appear in patent information with categorization sign B assigned thereto at high appearance frequency, and (2c) related term correspondence information indicative of a correspondence relation between categorization sign B and the related terms are stored in a related term database; categorization sign A is assigned to the patent information including the keywords (1b) above on the basis of the keyword correspondence information (1c) above; the patent information including the related terms (2b) above is extracted from the patent information to which categorization sign A is not assigned; scores are calculated based on evaluation values of, and the number of, the related terms; categorization sign B is assigned to the patent information, whose score exceeds a certain value, on the basis of the above-calculated scores and the related term correspondence information (2c) above; and assignment of categorization sign C to the patent information, to which categorization sign B is not assigned above, is accepted from a user.

Digital information including patent information and user information is acquired; user-identifying information indicating which user from among users included in the user information is related is set; the user is designated; a document file to which the user-identifying information corresponding to the designated user is set is searched; searched phrases are highlighted; and access right control is performed, which makes it possible to set various authorities for each viewer's account.

Digital information including patent information, user information, and access history information is acquired; a specified person is designated from among users included in the user information; only the patent information accessed by the specified person is extracted on the basis of access history information relating to the designated specified person; a full-text search function available in multi-languages is provided; and document files related to a specified intellectual property event are output from the extracted patent information.

A patent group is extracted from the patent information; input of categorization signs, which indicate the relation with a specified intellectual property event, is accepted from a reviewer in order to assign the categorization signs to the patent group; the patent group is categorized by each categorization sign; keywords which appear commonly in the categorized patent group are analyzed and selected; the patent information is searched for the selected keywords; scores indicative of the relation between the categorization signs and patents are calculated by using the searched result and the analysis result of the keywords; and the categorization signs are assigned to the patent information on the basis of the calculated scores.

Digital information including patent information and user information is acquired; user-identifying information indicating which user from among users included in the user information is related is set; the user is designated; a document file to which the user-identifying information corresponding to the designated user is set is searched; mail threads are displayed collectively; and information indicating whether each of document files included in the extracted patent information is related to a specified intellectual property event or not is accepted. The document files related to the specified intellectual property event are output.

Digital information including patent information and user information is acquired; designation of into which language document files included in the patent information should be translated is accepted; the document files are translated; common document files indicating the same content as that of a designated document file are extracted from the patent information; accessory information indicating whether each of the document files of the extracted patent information is related to a specified intellectual property event or not is set; and document files related to the specified intellectual property event are output on the basis of the translation related information and the accessory information.

Keywords for the reviewer to judge whether the relevant data is related to a specified intellectual property event or not are registered in a database; the patent information is searched for the keywords registered in the database; sentences including the searched keywords are extracted from the patent information; a score indicative of the degree of association with the specified intellectual property event is calculated according to a feature quantity extracted from the extracted sentences; and the degree of emphasis of the sentences is changed according to the score.

A result of relation judgment by the reviewer on the relation with a specified intellectual property event or a progress speed of the relation judgment is recorded as actual performance information; prediction information about the result or the progress speed is generated; the actual performance information is compared with the prediction information; and an icon that presents evaluation of the reviewer's relation judgment is generated on the basis of the comparison result.

Input of result information indicative of the relation between a patent group and a specified intellectual property event is accepted from the reviewer; evaluation values of elements, which appear commonly in the patent group, are calculated according to features of the elements with respect to each piece of the result information; the elements are selected based on the evaluation values; a score of document data is calculated on the basis of the selected elements and their evaluation values; and a recall ratio is calculated based on the score.

Patents are displayed to the reviewer; identification information (tag) assigned by the reviewer to an object patent to be reviewed on the basis of judgment as to whether the relevant data is related to a specified intellectual property event or not is accepted; a feature quantity of the object patent, regarding which the tag has been accepted, is compared with a feature quantity of a document; a score of the document corresponding to a specified tag is updated on the basis of the comparison result; and a display order of the patents to be displayed is controlled on the basis of the updated score.

When a source code is updated, the updated source code is recorded; an executable file is created from the recorded source code; the executable file is executed for verification; the executed verification result is transmitted; and a server accepts the distributed verification result.

A document group, regarding which the reviewer judges the relation between the document group and a specified intellectual property event, and a classification button for the reviewer to select a classification condition for classifying the document group are displayed; information about the classification button selected by the reviewer is accepted as selection information; the document data is classified according to an analysis result of the document group on the basis of the selection information; and the document group is displayed on the basis of the classification result.

Each piece of accessory information of document data is checked; the document data is classified into threads on the basis of the accessory information; elements included in the accessory information of the classified document data are extracted from each thread; the degree of similarity between the threads is analyzed on the basis of the extracted elements; and the threads are integrated on the basis of the degree of similarity.

A file with a password which is protected with the password is extracted; candidate words which are candidates for the password are input to the file with the password by using a dictionary file in which the candidate words are registered; and the result of judgment given by the reviewer on the file, whose password has been cleared, is accepted with respect to the relation with a specified intellectual property event.

Data of a search object file in a binary format is divided into a plurality of blocks; the search object file in the binary format is searched for block data; and the search result is output.

Object digital information (patent information) which is to be a research object is selected; a plurality of combinations of words having the relation with a specified matter (a specified intellectual property event) are stored; and the selected object digital information is searched to see whether it contains the plurality of stored combinations of words or not; and if the selected object digital information contains the plurality of stored combinations of words, the relation between the object digital information and the specified matter is judged on the basis of the result of morpheme analysis and the judgment result is associated with the object digital information.

A document group is extracted from patent information; input of categorization signs is accepted from the user in order to assign the categorization signs to the patent group; the document group is categorized by each categorization sign; keywords which appear commonly in the categorized document group are analyzed and selected; the patent information is searched for the selected keywords; a score is calculated by using the search result and the result of analyzing the keywords; the categorization signs are assigned to the patent information on the basis of the calculated score; the score calculation result and the categorization result are displayed on a screen; and the number of necessary documents for recheck is calculated on the basis of the relation between a recall ratio and a normalized rank.

(1a) Categorization sign A, (1b) keywords included in patent documents to which categorization sign A is assigned, and (1c) keyword correspondence information indicative of a correspondence relation between categorization sign A and the keywords are stored in a keyword database; (2a) categorization sign B, (2b) related terms which appear in patent documents with categorization sign B assigned thereto at high appearance frequency, and (2c) related term correspondence information indicative of a correspondence relation between categorization sign B and the related terms are stored in a related term database; categorization sign A is assigned to the patent documents including the keywords (1b) above on the basis of the keyword correspondence information (1c) above; patent documents including the related terms (2b) above are extracted from patent documents to which categorization sign A is not assigned above; scores are calculated based on evaluation values of, and the number of, the related terms; categorization sign B is assigned to patent documents, whose score exceeds a certain value, on the basis of the above-calculated scores and the related term correspondence information (2c) above; assignment of categorization sign C to patent documents, to which categorization sign B is not assigned, is accepted from the user; the patent documents to which categorization sign C is assigned are analyzed; and categorization sign D is assigned to patent documents, to which any categorization sign is not assigned, on the basis of the analysis result.

A score indicative of the relation with a specified intellectual property event is calculated with respect to each document (patent information). Documents are extracted in a specified order on the basis of the calculated score; categorization signs assigned by the reviewer to the extracted documents on the basis of the relation with the specified intellectual property event are accepted; the extracted documents are categorized by each categorization sign on the basis of the categorization signs; keywords which appear commonly in the categorized documents are analyzed and selected; the patent information is searched for the selected keywords; and the score is recalculated for each document by using the search result and the analysis result.

Information about a specified intellectual property event is stored in a research basic database; input of a category (such as a patent, a utility model, a design, or a trademark) of the specified intellectual property event is accepted; a research category which is a research object is judged on the basis of the accepted category; and the type of necessary information is extracted from the research basic database.

A behavior occurrence model prepared based on a reception/transmission history of message files of an acting subject, who performed a specific behavior, over a network is stored; profile information of the subject is created on the basis of the subject's reception/transmission history of message files over the network; a score indicative of conformity between the profile information and the behavior occurrence model is calculated; and the possibility of occurrence of the specified behavior is judged on the basis of the score.

Case research results including categorization work results of each case are collected with respect to a specified intellectual property event; a research model parameter for investigating the specified intellectual property event is registered; the registered research model parameter is searched upon input of research content of a new research case; a research model parameter related to input information is extracted; a research model is output by using the extracted research model parameter; and previous information is configured to conduct research on a new research case on the basis of the output result of the research model.

User information about a user is acquired; updated digital information is acquired at regular time intervals on the basis of the user information; a plurality of files constituting the acquired digital information are organized into a specified storage site on the basis of recording destination information, file names, and metadata with respect to the acquired digital information; and a visualized status distribution indicating the status of the plurality of organized files is created so that the status of users who accessed the digital information can be recognized.

Metadata associated with digital information is acquired; a set of weighted parameters is updated on the basis of the relation between first digital information, which has the relation with a specified matter, and the metadata; and the relation between morphemes and the digital information is updated by using the set of weighted parameters.

Categorization sign A manually assigned to object data is accepted; a relation score of object data is calculated; whether categorization sign A is true or false is judged on the basis of the relation score; and a categorization sign to be assigned to the object data is determined on the basis of the result of the true-or-false judgment.

Input of a category to which a specified intellectual property event belongs is accepted; research is conducted on the basis of the accepted category; a report is prepared to report the research result; information related to the specified intellectual property event is stored in an research basic database; a research category which is an research object is judged on the basis of the accepted category; necessary information types are extracted from the research basic database; the extracted necessary information types are presented to the reviewer; input of keywords and the like to be used to assign categorization signs corresponding to the presented information types is accepted from the reviewer; and the categorization signs are automatically assigned to documents (patent information).

Public information of a subject is acquired; the public information is analyzed; external elements of the subject are output; a behavior occurrence model based on external behavior elements of an acting subject who performed a specific behavior is stored; behavior factors, which match the behavior occurrence model, are extracted from the external elements of the subject and are stored; internal information of the subject is acquired; the internal information is analyzed; internal elements of the subject is output; and an analysis object is automatically identified on the basis of similarity between the internal elements and the behavior factors.

Relation information indicative of the relation between digital information and a specified matter is acquired from the reviewer; a relation score determined according to the relation between the digital information and the specified matter is calculated with respect to each piece of the digital information; a ratio of the number of pieces of relation information assigned to the digital information included in the relevant range to a total number of pieces of digital information having the relation score included in each range is calculated with respect to each specified range of the relation score; and a plurality of sections associated with the respective ranges are displayed by changing hue, brightness, or color intensity on the basis of the ratio.

Scores indicative of the strength of linkage between documents (patent information) and categorization signs are calculated in a time-series manner; time-series changes of the scores are detected from the calculated scores; upon judging the detected time-series changes of the scores, relevance between a research case and extracted documents are judged on the basis of the result of judging time when a score in excess of a specified reference value changed; weighted information which is related to a specified matter and associated with a plurality of keywords including co-occurrence expressions is stored; scores are associated with digital information; sample digital information, which is to be a sample, is extracted from the digital information on the basis of the scores; and the weighted information is updated by analyzing the extracted sample digital information.

Categories which are indexes capable of classifying each of documents included in a plurality of documents (patent information) are selected; and a score is calculated for each category.

A phase for classifying a specified act by a specified acting subject, which may cause a specified intellectual property event according to the progress of the specified act is specified on the basis of a score; and changes of the specified phase are estimated on the basis of time transient of the phase.

An occurrence process model regarding the occurrence of a specified act, which may cause a specified intellectual property event, is stored for each phase for classification according to the progress of the specified act; information related to the specified intellectual property event is stored for each category and each occurrence process model; time-series information indicative of a temporal order of the phase is stored; patent information is analyzed on the basis of the above-mentioned information; and an index indicative of the possibility of occurrence of the specified act is calculated from the analysis result.

Generation process models for causing a specified act, which may cause a specified intellectual property event, are stored by each phase for classification according to the progress of the specified act; information related to the specified intellectual property event is stored with respect to each category and each generation process model; time-series information indicative of temporal order of the phases is stored; the relationship between a plurality of persons related to the specified intellectual property event or unauthorized research is stored; patent information is analyzed on the basis of the above-mentioned information; and the present phase is identified.

When verbs representing actions are included in documents (patent information), objects which represents objects of the actions are identified; metadata indicative of attributes of the documents including the verbs and the objects are associated with the verbs and the objects; the relation between the documents and events is evaluated on the basis of the association; and the relationship between a plurality of persons related to the events is displayed.

Communication data transmitted and received between a plurality of terminals and associated with each of a plurality of persons is acquired; the content of the acquired communication data is analyzed; the relation between the content of the communication data and a specified intellectual property event is evaluated by using the analysis result; and the relationship between a plurality of persons related to the specified intellectual property event is displayed on the basis of the evaluation result.

A score indicative of the strength of linkage between documents included in patent information and categorization signs indicative of relevance between the patent information and a specified intellectual property event or unauthorized research is calculated; the score is reported to the user according to the calculated score; and a research report is output depending on a research type of the specified intellectual property event.

A reference is made to a database which stores confidential information associated with confidentiality; a degree of leakage indicating risks of leakage of the confidential information by access to the outside of a network is calculated; whether the confidentiality or the degree of leakage satisfies standards for leakage of the confidential information or not is judged; and a subject of leakage is identified when it is judged that the confidentiality or the degree of leakage satisfies standards for leakage of the confidential information.

Differences between group A of behaviors included in a certain period of time and group B of behaviors included in a most recent period of time are extracted by comparing group A with group B; whether or not the extracted differences satisfy standards indicative of increasing risks of leakage of the confidential information is judged; and when it is judged that the extracted differences satisfy standards indicative of increasing risks of leakage of the confidential information, the risks are reported to an administrator.

A keyword vector indicating whether a specified keyword is included in sentences contained in documents (patent information) or not is generated with respect to each sentence; a correlation vector is acquired with respect to each sentence by multiplying the keyword vector by the correlation matrix indicative of a correlation between the specified keyword and other keywords; and a score is calculated on the basis of a totalized value of all correlation vectors.

A threshold value for classifying unjudged data (untagged data which have not been judged by the reviewer) is specified from among scores calculated for judged data (tagged data which have been judged by the reviewer); and the unjudged data are set as data to be reported to the reviewer according to the results of comparison between the specified threshold value and the scores calculated for the unjudged data.

Weighting of keywords included in categorized documents (categorized patent information) regarding which whether they are related to a specified intellectual property event or not is categorized by the reviewer is learned; uncategorized documents regarding which whether they are related to the specified intellectual property event or not has not been categorized by the reviewer are searched for keywords included in the categorized documents; a score that evaluates the strength of linkage between the uncategorized documents and categorization signs is calculated by using weighting of the searched keywords and the learned keywords.

### REFERENCE SIGNS LIST

1 Intellectual property evaluation system; 11 right infringement analysis evaluation unit; 12 infringing nature analysis evaluation unit; 13 trade secret management evaluation unit; 14 electronic stamp management evaluation unit; 15 data input accepting unit; 16 operator input accepting unit; 17 web data input accepting unit; 18 memory unit; 19 element evaluation unit; 20 keyword extraction unit; 21 relation evaluation unit; 22 score calculation data extraction unit; 23 threshold value specifying unit; 24 score calculation unit; 25 data display unit; 30 evaluation result output unit; and 60 information storage apparatus.

1. An intellectual property evaluation system for evaluating a relation with a specified intellectual property event from data regarding acquired patent information,
the intellectual property evaluation system comprising:
an element evaluation unit that evaluates an element for evaluating the relation between the data regarding the acquired patent information and the specified intellectual property event and re-evaluates and updates the evaluated element;
a relation evaluation unit that evaluates the relation between the data regarding the acquired patent information and the specified intellectual property event on the basis of the element and re-evaluates and updates the relation between the data regarding the acquired patent information and the specified intellectual property event on the basis of the element which is updated by being re-evaluated on the basis of the evaluated relation;
a threshold value specifying unit that specifies a threshold value with respect to the relation acquired or updated by the relation evaluation unit and compares the relation or the updated relation with the threshold value; and
a patent information analysis unit that acquires the re-evaluated relation between the acquired patent information and the specified intellectual property event by controlling controls the element evaluation unit, the relation evaluation unit, and the threshold value specifying unit, and outputs the re-evaluated relation according to comparison between the re-evaluated relation and the threshold value as a result of the evaluation of the relation between the patent information and the specified intellectual property event.

2. The intellectual property evaluation system according to claim 1, comprising a right infringement analysis evaluation unit that specifies a patent, which is a basis for exercising a right, and evaluates a relation that a product has with the specified patent which is the basis for exercising the right.

3. The intellectual property evaluation system according to claim 2, wherein data regarding the product is updated and specified on the basis of a keyword searched on a web.

4. The intellectual property evaluation system according to claim 3, wherein the relation with the specified patent which is the basis for exercising the right is evaluated with respect to the data regarding the product.

5. The intellectual property evaluation system according to any one of claims 2 to 4, wherein the relation with the specified patent which is the basis for exercising the right is evaluated by calculating a score value indicative of strength of the relation with the specified intellectual property event with respect to the data regarding the product.

6. The intellectual property evaluation system according to claim 5, wherein the relation with the specified patent which is the basis for exercising the right is evaluated by extracting a keyword from the data regarding the product regarding which the calculated score value is high.

7. The intellectual property evaluation system according to any one of claims 2 to 6, wherein a claim chart is created based on the evaluation of the relation with the specified patent which is the basis for exercising the right.

8. The intellectual property evaluation system according to any one of claims 1 to 7, comprising an infringing nature analysis evaluation unit that specifies a product and evaluates a relation that a patent acquired by searching for the specified product has with the specified product.

9. The intellectual property evaluation system according to any one of claims 1 to 8, comprising a trade secret management evaluation unit that: extracts data regarding a trade secret and evaluates a relation between the extracted data regarding the trade secret and the trade secret; monitors external taking-out or transmission preparation work of the extracted data regarding the trade secret when the relation exceeds a specified threshold value; and executes processing for dealing with the external taking-out or the preparation work when the external taking-out or the preparation work is detected.

10. The intellectual property evaluation system according to any one of claims 1 to 9, comprising an electronic stamp management evaluation unit that: selects an object of an electronic stamp; evaluates an element for specifying the object of the electronic stamp; extracts electronic stamp candidate data from the acquired data; evaluates a relation of the electronic stamp candidate data on the basis of the evaluated element; updates the evaluated element and relation; and certifies electronic stamp processing and transmits the electronic stamp processing when the evaluated or updated relation exceeds a specified value.

11. An intellectual property evaluation system control method for evaluating a relation with a specified intellectual property event from data regarding acquired patent information,
the intellectual property evaluation system control method comprising:
an element evaluation step of evaluating an element for evaluating the relation between the data regarding the acquired patent information and the specified intellectual property event;
a relation evaluation step of evaluating the relation between the data regarding the patent information acquired by the data input accepting unit and the specified intellectual property event on the basis of the element;
an element re-evaluation step of re-evaluating the element for evaluating the relation between the data regarding the acquired patent information and the specified intellectual property event;
a relation re-evaluation step of re-evaluating the relation between the data regarding the acquired patent information and the specified intellectual property event on the basis of the re-evaluated element;
a comparison step of comparing the re-evaluated relation with a threshold value specified with respect to the relation; and
an output step of outputting the re-evaluated relation according to the comparison with the threshold value as a result of the evaluation of the relation between the patent information and the specified intellectual property event.

12. An intellectual property evaluation program for evaluating a relation with a specified intellectual property event from data regarding acquired patent information,
the intellectual property evaluation program causing a computer to implement:
an element evaluation function that evaluates an element for evaluating the relation between the data regarding the acquired patent information and the specified intellectual property event;
a relation evaluation function that evaluates the relation between the data regarding the patent information acquired by the data input accepting unit and the specified intellectual property event on the basis of the element;
an element re-evaluation function that re-evaluates the element for evaluating the relation between the data regarding the acquired patent information and the specified intellectual property event;
a relation re-evaluation function that re-evaluates the relation between the data regarding the acquired patent information and the specified intellectual property event on the basis of the re-evaluated element;
a comparison function that compares the re-evaluated relation with a threshold value specified with respect to the relation; and
an output function that outputs the re-evaluated relation according to the comparison with the threshold value as a result of the evaluation of the relation between the patent information and the specified intellectual property event.
